(19) United States
(12) Patent Application Publication
(10) Pub. No.: US 2006/0086050 A1
(43) Pub. Date: Apr. 27, 2006

(54) Automatic door opening/closing detection system and automatic door opening/closing detection method

(75) Inventors: Toshiyasu Matsuyama, Shiga (JP); Masaya Kida, Shiga (JP)

Correspondence Address: MORGAN LEWIS & BOCKIUS LLP, 1111 PENNSYLVANIA AVENUE NW, WASHINGTON, DC, 20004, US

(73) Assignee: Optex Co., Ltd.

(21) Appl. No.: 11/254,767

(22) Filed: Oct. 21, 2005

(30) Foreign Application Priority Data
Oct. 22, 2004 (JP) 2004-308943

(51) Int. Cl. E05C 7/04

(52) U.S. Cl. 49/366

(57) ABSTRACT

The present invention provides an automatic door opening/closing detection system and an automatic door opening/closing detection method which are capable of preventing door main bodies from malfunctioning, for example, from being left open, even when the door main bodies are manually opened. An examplary automatic door opening/closing detection system includes: a pair of door main bodies 12, 14 opening/closing relative to an opening part; driving parts 20, 22 rotary driving the door main bodies 12, 14; a control part 24 controlling the rotary driving of the door main bodies 12, 14 by the driving parts 20, 22; and a sensing part discriminating an open position in which the door main bodies 12, 14 are open relative to the opening part, a closed position in which the door main bodies 12, 14 are closed relative to the opening part, and a partially open/partially closed position in which one of the door main bodies 12, 14 is open relative to part of the opening part and the other of the door main bodies 12, 14 is closed relative to part of the opening part, and controlling the control part 24 based on the discrimination result.

### BACKGROUND OF THE INVENTION

1. Field of the Invention

The present invention relates to an automatic door opening/closing detection system and an automatic door opening/closing detection method that are capable of detecting the opening/closing position of an automatic door.

2. Description of the Related Art

Conventionally, a so-called double-leaf automatic swing door system has been known. As shown in FIG. 9(A), a double-leaf automatic swing door system 100 includes: a pair of door main bodies 102, 104 disposed in an opening part 101; motors 110, 112 rotating the respective door main bodies 102, 104 on rotary pivots 106, 108 attached to the respective door main bodies 102, 104; and a control part 114 controlling the motors 110, 112. The door main bodies 102, 104 in a closed position are positioned so that one-side widthwise end portions thereof face each other. Driving one or both of the door main bodies 102, 104 in this position by the motor(s) 110, 112 causes the one or both of the door main bodies 102, 104 to rotate on the rotary pivot(s) 106, 108, thereby bringing one or both of the door main bodies 102, 104 into an open position.

Here, from a viewpoint of ensuring safety, a sensor for object detection on the door path (not shown) is disposed near the door main bodies 102, 104. The sensor for object detection on the door path is capable of recognizing the opening/closing position of the door main bodies 102, 104 by utilizing a motor voltage of one of the motors 110, 112. Specifically, the motor voltage of the motors 110, 112 driving the door main bodies 102, 104 is low when the door main bodies 102, 104 are in the closed position, while being high when the door main bodies 102, 104 are in the open position. The sensor for object detection on the door path judges whether the door main bodies 102, 104 are in the closed position or the open position by detecting a change in the motor voltage. Further, at the same time, the sensor for object detection on the door path is capable of detecting a person or the like existing near the door main bodies 102, 104, to control the driving of the motors 110, 112 via the control part 114.

Since the sensor for object detection on the door path controls the motors 110, 112 based on the detection result of the motor voltage of only one (for example, the motor 112) of the motors 110, 112 rotary driving the door main bodies 102, 104, it has the following problem. Specifically, it cannot recognize the opening/closing position of the other door main body 102 rotary driven by the motor 110 whose motor voltage is not detected (which is not controlled by the sensor for object detection on the door path).

This causes the following problem. That is, for example, when the door main body 102 which is not controlled by the sensor for object detection on the door path is manually opened as shown in FIG. 9(B), this opened door main body 102 is erroneously detected as a person or an object by the sensor for object detection on the door path, so that the door main body 102 not controlled by the sensor for object detection on the door path is left open as shown in FIG. 9(C).

There also occurs another problem. That is, when the door main body 102 remains opened as shown in FIG. 9(C) for a predetermined time, the sensor for object detection on the door path recognizes the door main body 102, which has been left open, as being in the closed position. Then, when the door main body 102 left open is attempted to be manually closed as shown in FIG. 10(A), the sensor for object detection on the door path erroneously detects the door main body 102 as a person or an object, so that the detection position continues until a predetermined time passes even when the door main body 102 is completely closed as shown in FIG. 10(B) and the door main bodies 102, 104 do not open even when a person tries to pass therethrough.

If two sensors for object detection on the door path are provided to detect the motor voltages of both of the motors 110, 112, it might be able to solve the problem but gives rise to another problem. Specifically, the increase in the number of the sensors for object detection on the door path leads to higher manufacturing cost and to increased trouble in attaching the sensors for object detection on the door path.

### SUMMARY OF THE INVENTION

Therefore, considering the above-described circumstances, it is an object of the present invention to provide an automatic door opening/closing detection system and an automatic door opening/closing detection method that are capable of preventing door main bodies from malfunctioning, for example, from being left open, even when the door main bodies are manually opened.

An exemplary embodiment of the present invention includes: a pair of door main bodies opening/closing relative to an opening part; a driving part driving the door main bodies; a control part controlling the driving of the door main bodies by the driving part; a sensing part discriminating an open position in which the door main bodies are open relative to the opening part, a closed position in which the door main bodies are closed relative to the opening part, and a partially open/partially closed position in which one of the door main bodies is open relative to part of the opening part and the other of the door main bodies is closed relative to part of the opening part, and controlling the control part based on a result of the discrimination.

According to an aspect of the invention, the sensing part discriminates the open position in which the door main bodies are open relative to the opening part, the closed position in which the door main bodies are closed relative to the opening part, and the partially open/partially closed position in which one of the door main bodies is open relative to part of the opening part and the other of the door main bodies is closed relative to part of the opening part. Further, the sensing part controls the control part based on the aforesaid discrimination result.

Therefore, when one of the door main bodies is manually opened from the closed position in which the opening part is closed by the pair of door main bodies, and thus the closed position shifts to the partially open/partially closed position in which part of the opening part is open and the other door main body keeps part of the opening part closed, the sensing part recognizes that the current position is the partially open/partially closed position. As a result, even when one of the door main bodies is manually opened, the sensing part does not erroneously sense the opened door as a person or an object and thus does not erroneously control the control part and the driving part. Therefore, it is possible to prevent the door main bodies from malfunctioning when they are thereafter driven.

Note that “the partially open/partially closed position” in this specification includes a position in which one (for example the right one) of the pair of door main bodies is open and the other door main body (for example, the left one) is closed as well as a position in which the other (for example, the left one) of the pair of door main bodies is open and the one (for example, the right one) of the door main bodies is closed.

According to another aspect of the invention, in the automatic door opening/closing detection system discussed above, the sensing part further discriminates a position in which a person or an object exists on paths of the door main bodies, and controls the control part so as to stop the driving of the door main bodies when recognizing the position in which the person or the object exists on the paths of the door main bodies.

According to a further aspect of the invention, the sensing part further discriminates the position in which a person or an object exists on the paths of the door main bodies. Then, the sensing part, when recognizing this position, controls the control part so as to stop the driving of the door main bodies. Consequently, the door main bodies are not driven. Thus, when the sensing part recognizes the position in which a person or an object exists on the paths of the door main bodies in the partially open/partially closed position, the door main bodies are not driven. This can prevent the door main bodies from coming into contact with the person or object existing on the paths of the door main bodies.

A method according to an aspect of the present invention includes: a position discriminating step of discriminating by a sensing part an open position in which a pair of door main bodies are open relative to an opening part, a closed position in which the door main bodies are closed relative to the opening part, and a partially open/partially closed position in which one of the door main bodies is open relative to part of the opening part and the other of the door main bodies is closed relative to part of the opening part; and a control step of controlling, by the sensing part, a control part based on a result of the discrimination of the sensing part to control the driving of the door main bodies.

According to another aspect of a method in accordance with the present invention, in the position discriminating step, the sensing part discriminates the open position in which the pair of door main bodies are open relative to the opening part, the closed position in which the door main bodies are closed relative to the opening part, and the partially open/partially closed position in which one of the door main bodies is open relative to part of the opening part and the other door main body is closed relative to part of the opening part.

Further, in the control step, the sensing part may control the control part based on the discrimination result of the sensing part to control the driving of the door main bodes. For example, when one of the door main bodies is manually opened from the closed position in which the opening part is closed by the pair of door main bodies, and thus the closed position shifts to the partially open/partially closed position in which part of the opening part is open and part of the opening part is kept closed by the other door main body, the sensing part recognizes that the current position is the partially open/partially closed position. As a result, even when one of the door main bodies is manually opened, the sensing part does not erroneously sense the opened door main body as a person or an object, and thus does not erroneously control the control part and the driving part. Therefore, it is possible to prevent the door main bodies from malfunctioning when they are thereafter driven.

According to a further aspect of a method in accordance with the present invention, in the automatic opening/closing detection method discussed above, the position discriminating step further includes discriminating by the sensing part a position in which a person or an object exists on paths of the door main bodies, and the control step includes controlling the control part so as to stop the driving of the door main bodies when the sensing part recognizes the position in which the person or the object exists on the paths of the door main bodies.

In addition, the position discriminating step may further include discriminating by the sensing part the position in which a person or an object exists on the paths of the door main bodies. Further, the control step may include controlling by the sensing part the control part so as to stop the driving of the door main bodies when the sensing part recognizes the position in which the person or the object exists on the paths of the door main bodies. Consequently, the door main bodies are not driven. Thus, when the sensing part recognizes the position in which a person or an object exists on the paths of the door main bodies in the partially open/partially closed position, the door main bodies are not driven. This can prevent the door main bodies from coming into contact with the person or object existing on the paths of the door main bodies.

### BRIEF DESCRIPTION OF THE DRAWINGS

FIG. 1 is a block diagram showing a configuration of an automatic door opening/closing detection system according to an embodiment;

FIG. 2(A) is a plane view showing an open position in which door main bodies are open relative to an opening part, and FIG. 2(B) is a plane view showing a closed position in which the door main bodies are closed relative to the opening part;

FIG. 3(A) is a plane view showing a position in which one of the door main bodies is manually pushed, and FIG. 3(B) is a plane view showing a partially open/partially closed position in which one of the door main bodies is open relative to part of the opening part and the other door main body is closed relative to part of the opening part;

FIG. 4(A) is a plane view showing a position in which one of the door main bodies is attempted to close the opening part from the partially open/partially closed position, and FIG. 4(B) is a plane view showing a closed position in which one of the door main bodies completely closes part of the opening part;

FIG. 5 is a flowchart showing processing starting from the closed position according to the automatic door opening/closing detection system of this embodiment;

FIG. 6 is a flowchart showing processing starting from the open position according to the automatic door opening/closing detection system of this embodiment;

FIG. 7 is a flowchart showing processing according to the automatic door opening/closing detection system of this embodiment, with the partially open/partially closed position included in the flow;

FIG. 8 is a flowchart showing processing different from the processing shown in FIG. 7 according to the automatic door opening/closing detection system of this embodiment, with the partially open/partially closed position included in the flow;

FIG. 9(A), FIG. 9(B), and FIG. 9(C) are views showing a rough structure of a conventional double-leaf automatic swing door system, in particular, FIG. 9(A) being a plane view showing a closed position in which door main bodies are closed relative to an opening part, FIG. 9(B) being a plane view showing a position in which one of the door main bodies is manually pushed, and FIG. 9(C) being a plane view showing a partially open/partially closed position in which one of the door main bodies is open relative to part of the opening part and the other door main body is closed relative to part of the opening part; and

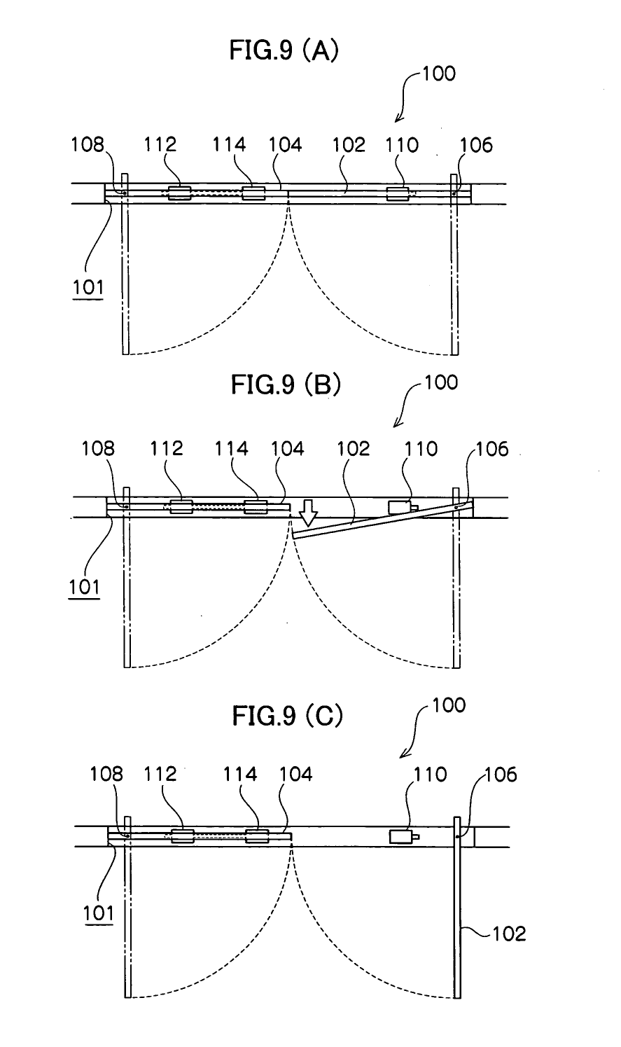

FIG. 10(A) and FIG. 10(B) are views showing a rough structure of the conventional double-leaf automatic swing door system, in particular, FIG. 10(A) being a plane view showing a position in which one the door main bodies is attempted to close the opening part from the partially open/partially closed position and FIG. 10(B) being a plane view showing a closed position in which one of the door man bodies completely closes the opening part.

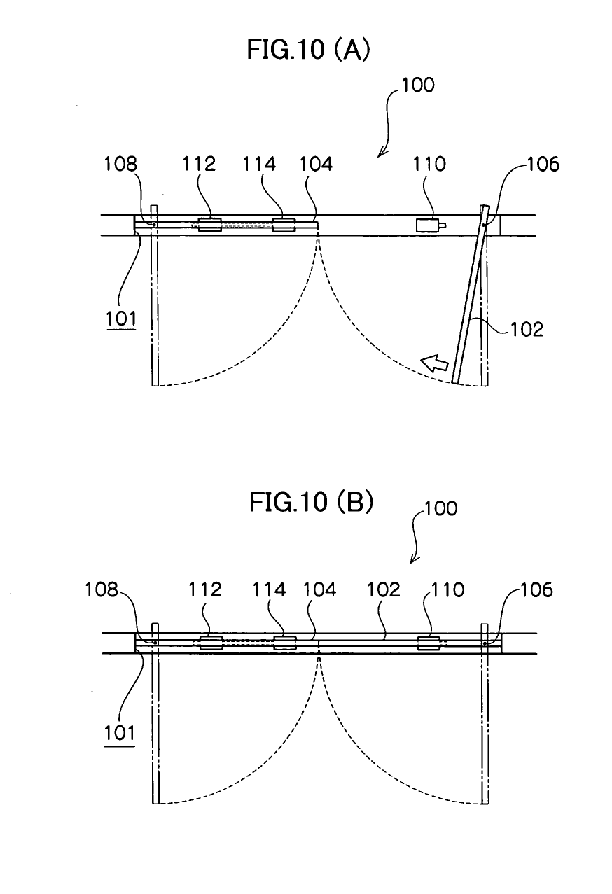

### DETAILED DESCRIPTION OF THE PREFERRED EMBODIMENTS

An automatic door opening/closing detection system according to one embodiment of the present invention will be described with reference to the drawings. It should be noted that, though this embodiment will describe, as an example, a structure in which a swing door is used as an automatic door, the present invention is not limited to the swing door but is applicable to all automatic doors that open/close automatically, such as, for example, a folding door.

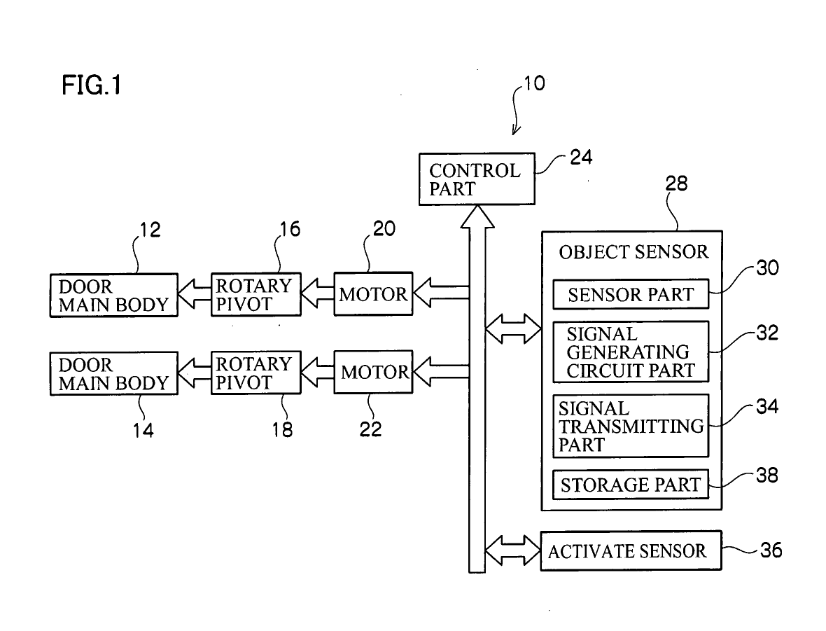

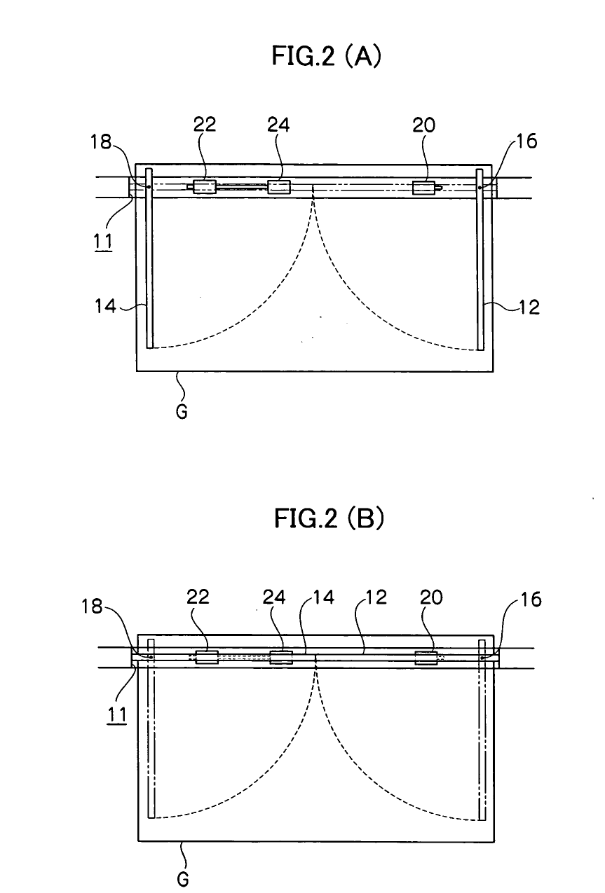

As showing in FIG. 1 and FIGS. 2(A), 2(B), a swing door opening/closing detection system (an automatic door opening/closing detection system) 10 includes a swing door. The swing door is composed of a pair of door main bodies 12, 14. The door main bodies 12, 14 are formed in a rectangular shape, and rotary pivots 16, 18 pass through outer widthwise end portions of the door main bodies 12, 14 respectively. The door main bodies 12, 14 are attached to an opening part 11 via the rotary pivots 16, 18. Further, motors (driving parts) 20, 22 for rotary driving the rotary pivots 16, 18 respectively are disposed near the opening part 11. When the motors 20, 22 are driven, the respective rotary pivots 16, 18 are rotary driven, so that the door main bodies 12, 14 are rotary driven together with the rotary pivots 16, 18. A control part (a control part) 24 for controlling the driving of the motors 20, 22 is further disposed near the motors 20, 22. According to an output signal from the control part 24, the motors 20, 22 are controlled to be driven/stopped.

Further, as shown in FIG. 1, an object sensor (a sensing part) 28 (not shown in FIG. 2(A) to FIG. 4(B) is disposed near the opening part 11. The object sensor 28 includes a sensor part 30 sensing a person or an object existing in a sensing area G on paths of the door main bodies 12, 14. The object sensor 28 further includes a storage part 38 storing a table showing the correspondence relation between rotation angles of the rotary pivots 16, 18 and motor voltages of the motors 20, 22. Note that the storage part 38 is not essential. For example, detecting the rotation angles or the like of the rotary pivots 16, 18 by using a door position detection sensor (not shown) eliminates a need for detecting the motor voltages and allows easy recognition of the opening/closing position of each of the door main bodies 12, 14. The object sensor 28 also includes a signal generating circuit part 32. Based on the motor voltages of the motors 20, 22, an output signal from the sensor part 30, and the table stored in the storage part 38, the signal generating circuit part 32 generates a first signal indicating an open position in which the door main bodies 12, 14 are open relative to the opening part 11, a second signal indicating a closed position in which the door main bodies 12, 14 are closed relative to the opening part 11, a third signal indicating a partially open/partially closed position in which one of the door main bodies 12, 14, for example, the door main body 12 (14) is open relative to part of the opening part 11 and the other of the door main bodies 12, 14, namely, the door main body 14 (12) is closed relative to part of the opening part 11, and a fourth signal indicating a position in which a person or an object exists on paths of the door main bodies 12, 14. The object sensor 28 further includes a signal transmitting part 34, which outputs the signals generated in the signal generating circuit part 32 to the control part 24. The control part 24, when receiving any of the signals, controls the rotary driving of the door main bodies 12, 14 via the rotary pivots 16, 18 based on the received signal. For example, when the fourth signal is generated by the signal generating circuit part of the object sensor 28, the fourth signal is outputted to the control part 24 to stop the rotary driving of the door main bodies 12, 14.

Further, as shown in FIG. 1, a activate sensor 36 (not shown in FIG. 2(A) to FIG. 4(B)) is disposed near the opening part 11. The activate sensor 36 is, for example, of a button type and detects a person when a button is pushed by the person, to output a predetermined signal to the control part 24. When the predetermined signal is outputted to the control part 24, the motors 20, 22 are controlled to be driven based on this signal and accordingly the door main bodies 12, 14 are rotary driven, so that the opening part is opened.

Incidentally, the object sensor 28 used in this embodiment includes the signal generating circuit part 32 for generating the predetermined signals, but other structure is the same as that of an existing sensor for sensing a person and an object.

Further, in the above description, the object sensor 28 used in this embodiment includes the signal generating circuit part 32 generating the predetermined signals. However, this structure is not restrictive, but a possible alternative structure may be such that a signal transmitting device (not shown) including a signal generating circuit part generating the aforesaid signals is disposed separately from the object sensor, and this signal transmitting device transmits the predetermined signals to the object sensor. A CPU (not shown) provided in the object sensor may discriminate the positions of the door main bodies 12, 14 based on any of the signals transmitted to the object sensor, and the signal transmitting part 34 may transmit a control signal to the control part 24 based on the discrimination result.

Further, this embodiment has described the example where the object sensor 28 and the activate sensor 36 are separate bodies. However, this structure is not restrictive, but a sensor in which the both sensors are integrated may be used.

Next, an automatic door opening/closing detection method using the automatic door opening/closing detection system 10 according to this embodiment will be described.

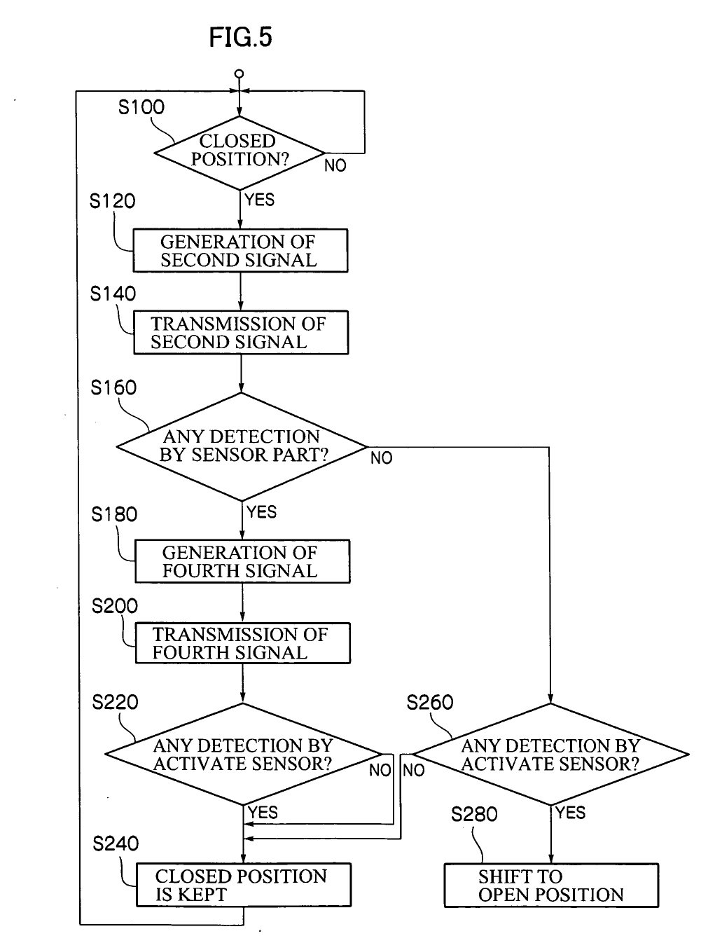

As shown in FIG. 1, FIGS. 2(A), 2(B), and FIG. 5, the object sensor 28 judges whether or not the current position is the closed position (see FIG. 2(B)) in which the door main bodies 12, 14 are closed relative to the opening part 11 (Step S100). The signal generating circuit part 32 makes this judgment based on the motor voltage of one of the motors 20 (22) and the table stored in the storage part 38. Accordingly, the object sensor 28 can judge whether or not the current position is the closed position, and can recognize that the current position is the closed position under a certain condition. When recognizing that the current position is the closed position, the signal generating circuit part 32 generates the second signal (Step S120). The generated second signal is transmitted from the signal transmitting part 34 to the control part 24 (Step S140).

Here, it is judged whether or not the sensor part 30 has sensed a person (or an object) in the sensing area G on the paths of the door main bodies 12, 14 (Step S160). When it is judged that the sensor part 30 has sensed a person (or an object) in the sensing area G on the paths of the door main bodies 12, 14, the signal generating circuit part 32 generates the fourth signal (Step S180). When the signal generating circuit part 32 generates the fourth signal, the signal transmitting part 34 transmits the fourth signal to the control part 24 (Step S200). The control part 24, when receiving the fourth signal, outputs a predetermined signal to the motors 20, 22 based on the second signal and the fourth signal, and controls the motors 20, 22 so as not to be driven even if the activate sensor 36 detects a person (Step S220). This prevents the door main bodies 12, 14 from being rotary driven together with the rotary pivots 16, 18, so that the closed position is kept (Step S240). Therefore, the door main bodies 12, 14 do not come into contact with the person (or object) in the sensing area G.

Thus, while the sensor part 30 senses a person (or an object) in the sensing area G, the signal transmitting part 34 continuously outputs the fourth signal to the control part 24, so that the door main bodies 12, 14 do not open, even when the activate sensor 36 detects a person.

Further, when the sensor part 30 no longer senses any person in the sensing area G, the fourth signal is not outputted to the control part 24. In this position, when the activate sensor 36 detects a person (Step S260), the control part 24 controls the motors 20, 22 to be driven, so that the rotary pivots 16, 18 are rotary driven. Consequently, the door main bodies 12, 14 are rotary driven together with the rotary pivots 16, 18, so that the opening part 11 is opened as shown in FIG. 2(A) (Step S280). On the other hand, when the activate sensor 36 does not detect any person (Step S260), the closed position is kept (Step S240).

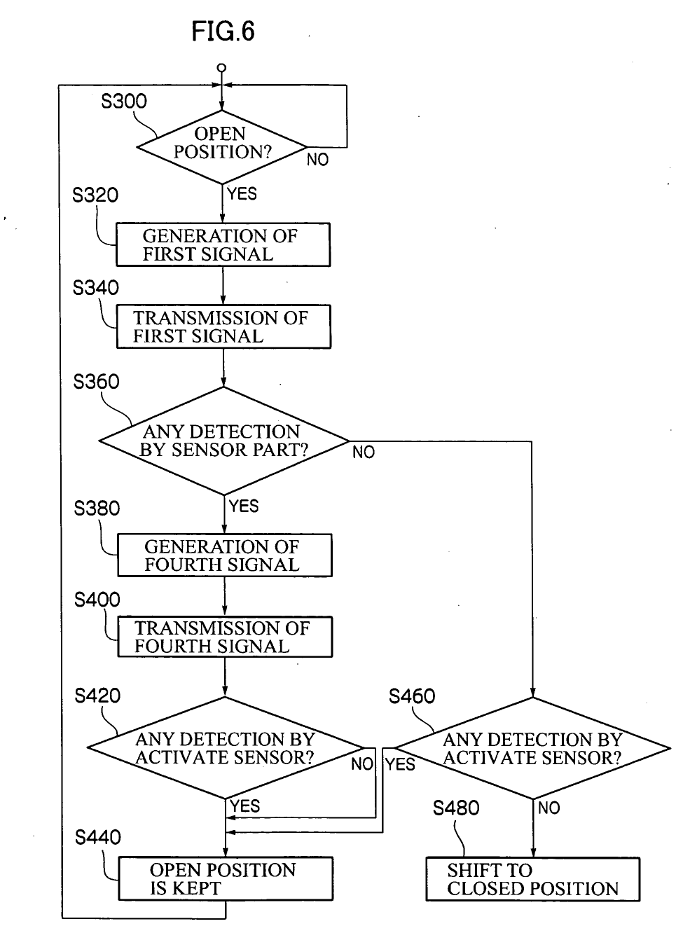

Meanwhile, as shown in FIG. 1, FIGS. 2(A), 2(B), and FIG. 6, the object sensor 28 judges whether or not the current position is the open position (see FIG. 2(A)) in which the door main bodies 12, 14 are open relative to the opening part 11 (Step S300). The signal generating circuit part 32 makes this judgment based on the motor voltage of one of the motors 20 (22) and the table stored in the storage part 38. Accordingly, the object sensor 28 can discriminate whether or not the current position is the open position, and can recognize that the current position is the open position under a certain condition. When recognizing that the current position is the open position, the signal generating circuit part 32 generates the first signal (Step S320). The generated first signal is transmitted from the signal transmitting part 34 to the control part 24 (Step S340).

Here, it is judged whether or not the sensor part 30 has sensed a person (or an object) in the sensing area G on the paths of the door main bodies 12, 14 (Step S360). When the sensor part 30 has sensed a person (or an object) in the sensing area G on the paths of the door main bodies 12, 14, the signal generating circuit part 32 generates the fourth signal (Step S380). When the signal generating circuit part 32 generates the fourth signal, the signal transmitting part 34 transmits the fourth signal to the control part 24 (Step S400). The control part 24, when receiving the fourth signal, outputs a predetermined signal to the motors 20, 22 based on the first signal and the fourth signal and controls the motors 20, 22 so as not to be driven, even when the activate sensor 36 detects a person (Step S420). This prevents the door main bodies 12, 14 from being rotary driven together with the rotary pivots 16, 18, so that the open position is kept (Step S440). Therefore, the door main bodies 12, 14 do not come into contact with the person (or object) in the sensing area G.

Thus, the signal transmitting part 34 continuously outputs the fourth signal to the control part 24 while the sensor part 30 senses a person (or an object in the sensing area G, so that the door main bodies 12, 14 are not closed even when the activate sensor 36 does not detect any person.

Moreover, when the sensor part 30 no longer senses any person (or any object) in the sensing area G, the fourth signal is not outputted to the control part 24. In this position, when the activate sensor 36 does not detect any person (Step S460), the motors 20, 22 are controlled to be driven by the control part 24 and accordingly the rotary pivots 16, 18 are rotary driven. As a result, the door main bodies 12, 14 are rotary driven together with the rotary pivots 16, 18 to close the opening part 11 as shown in FIG. 2(B) (Step S480). On the other hand, when the activate sensor 36 detects a person (Step S460), the open position is kept (Step S440).

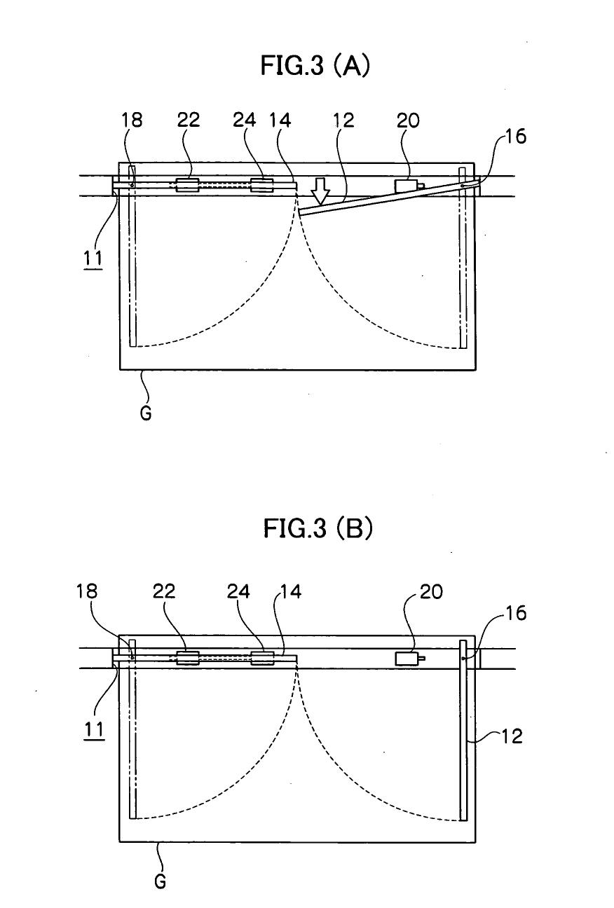

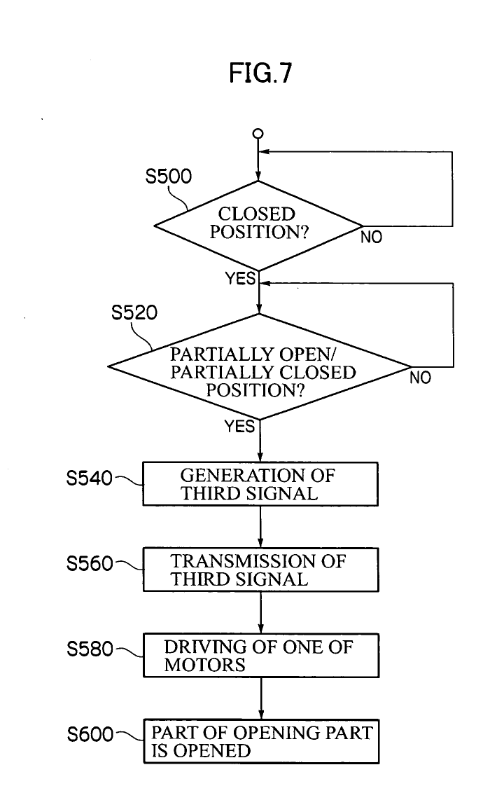

Further, as shown in FIGS. 3(A), 3(B) and FIG. 7, when one of the door main bodies 12, 14, for example, the door main body 12 is manually pushed to be opened in the closed position in which the door main bodies 12, 14 are closed relative to the opening part 11 (Step S500) and in the position in which the button is not pushed and thus the activate sensor 36 does not detect any person, the signal generating circuit part 32 judges whether or not the current position is the partially open/partially closed position, based on the motor voltage of the motor 20 out of the motors 20, 22 and the table stored in the storage part 38 (Step S520). As a result, the object sensor 28 can recognize that the current position is the partially open/partially closed position under a certain condition. When recognizing that the current position is the partially open/partially closed position, the signal generating circuit part 32 generates the third signal (Step S540). The generated third signal is transmitted from the signal transmitting part 34 to the control part 24 (Step S560). When the third signal is transmitted to the control part 24, the control part 24 outputs a predetermined signal to the motor 20 so that the motor 20 is driven (Step S580). When the motor 20 is driven, the door main body 12 manually pushed is rotary driven together with the rotary pivot 16, so that part of the opening part 11 is completely opened (Step S600). This allows the passage of a person. Moreover, even when the door main body 12 is manually opened, the opened door main body 12 is not erroneously judged as a person or baggage. Therefore, the control part 24 does not erroneously control the motors 20, 22, which can prevent the malfunction of the door main bodies 12, 14.

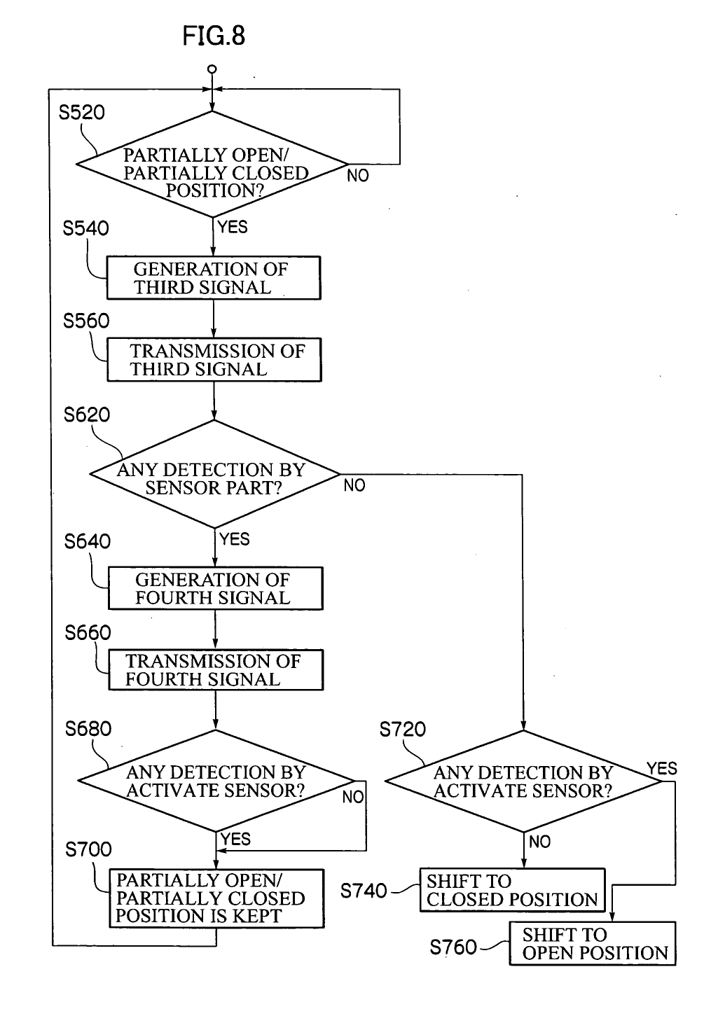

As shown in FIG. 8, when the signal generating circuit part 32 recognizes that the current position is the partially open/partially closed position (Step S520), the signal generating circuit part 32 generates the third signal (Step S540). The generated third signal is transmitted from the signal transmitting part 34 to the control part 24 (Step S560). At this time, when the sensor part 30 senses a person (or an object) in the sensing area G on the paths of the door main bodies 12, 14 (Step S620), the signal generating circuit part 32 generates the fourth signal (Step S640). When the signal generating circuit part 32 generates the fourth signal, the signal transmitting part 34 transmits the fourth signal to the control part 24 (Step S660). When the signal transmitting part 34 transmits the fourth signal to the control part 24, the control part 24 outputs a predetermined signal to the motors 20, 22 based on the third signal and the fourth signal and controls the motors 20, 22 so as not to be driven even if the activate sensor 36 detects a person (Step S680). This prevents the door main bodies 12, 14 from being rotary driven together with the rotary pivots 16, 18, so that the partially open/partially closed position is kept (Step S700). Therefore, the door main bodies 12, 14 do not come into contact with the person (or the object) existing on the paths of the door main bodies 12, 14.

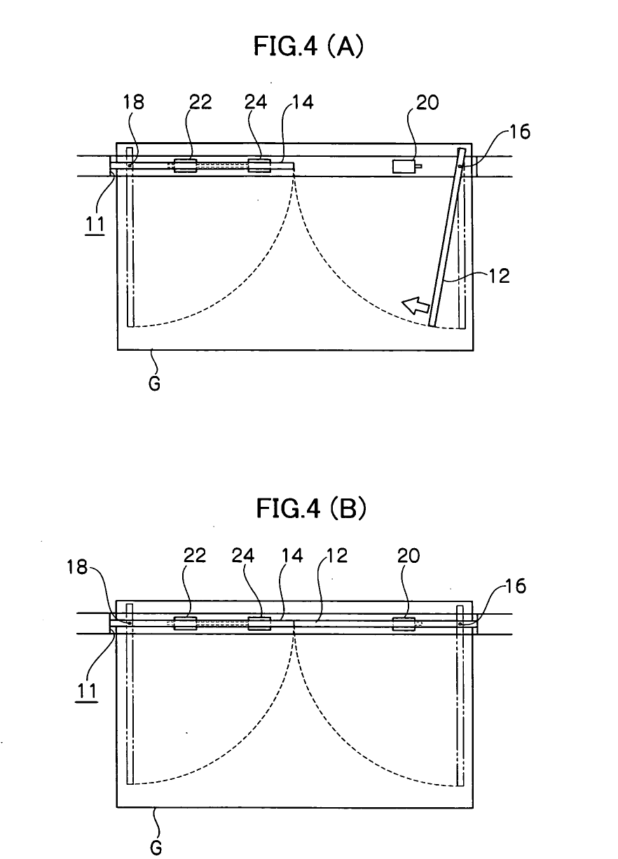

Further, when the sensor part 30 no longer senses any person (or any object) in the sensing area G, the fourth signal is not transmitted to the control part 24. In this position, when the activate sensor 36 does not detect any person (Step S720), the motor 20 is controlled to be driven by the control part 24, so that the rotary pivot 16 is rotary driven. Therefore, the door main body 12 is rotary driven together with the rotary pivot 16 to close part of the opening part 11 as shown in FIGS. 4(A), 4(B) (Step S740). On the other hand, when the activate sensor 36 detects a person (Step S720), the other motor 22 is controlled to be driven by the control part 24, so that the other rotary pivot 18 is rotary driven. Consequently, the other door main body 14 that has been closed is rotary driven together with the rotary pivot 18, so that the opening part 11 is opened, as shown in FIG. 2(A) (Step S760).

As has been described hitherto, according to the present invention, even when one of the pair of door main bodies 12, 14, for example, the door main body 12 is manually opened from the closed position in which the pair of door main bodies 12, 14 are closed relative to the opening part 11, the sensor part 30 does not erroneously sense this opened door main body 12 as a person or an object, and thus does not erroneously control the control part 24 and the motors 20, 22. Therefore, it is possible to prevent the door main bodies 12, 14 from malfunctioning when they are thereafter rotary driven.

In particular, when a person or an object such as baggage exists on the paths of the door main bodies 12, 14, the signal generating circuit part 32 generates the fourth signal, and the signal transmitting part 34 transmits the fourth signal to the control part 24, so that the door main bodies 12, 14 are not rotary driven. This can prevent the door main bodies 12, 14 from coming into contact with the person or object existing on the paths of the door main bodies 12, 14.

According to the present invention, it is possible to prevent the door main bodies from malfunctioning, for example, from being left open, even when the door main bodies are manually opened. In particular, the door main bodies are not driven when, in the partially open/partially closed position, the sensing part recognizes the position in which a person or an object exists on the paths of the door main bodies. Therefore, the door main bodies are prevented from coming into contact with the person or the object existing on the paths of the door main bodies.

What is claimed is:

1. An automatic door opening/closing detection system comprising:
a pair of door main bodies opening/closing relative to an opening part;
a driving part driving said door main bodies;
a control part controlling the rotary driving of said door main bodies by said driving part;
a sensing part discriminating an open position in which said door main bodies are open relative to the opening part, a closed position in which said door main bodies are closed relative to the opening part, and a partially open/partially closed position in which one of said door main bodies is open relative to part of the opening part and the other of said door main bodies is closed relative to part of the opening part, and controlling said control part based on a result of the discrimination.

2. The automatic door opening/closing detection system according to claim 1,
wherein said sensing part further discriminates a position in which a person or an object exists on paths of said door main bodies, and controls said control part so as to stop the driving of said door main bodies when recognizing the position in which the person or the object exists on the paths of said door main bodies.

3. An automatic door opening/closing detection method comprising:
a position discriminating step of discriminating by a sensing part an open position in which a pair of door main bodies are open relative to an opening part, a closed position in which the door main bodies are closed relative to the opening part, and a partially open/partially closed position in which one of the door main bodies is open relative to part of the opening part and the other of the door main bodies is closed relative to part of the opening part; and
a control step of controlling, by a sensing part, a control part based on a result of the discrimination of the sensing part to control the driving of the door main bodies.

4. The automatic door opening/closing detection method according to claim 3,
wherein said position discriminating step further includes discriminating by the sensing part a position in which a person or an object exists on paths of the door main bodies, and
wherein said control step includes controlling the control part so as to stop the driving of the door main bodies when the sensing part recognizes the position in which the person or the object exists on the paths of the door main bodies.
